(19) United States
(12) Patent Application Publication
(10) Pub. No.: US 2020/0305402 A1
(43) Pub. Date: Oct. 1, 2020

(54) Collapsible Umbrella Rig

(71) Applicant: KoongMeng Paul Xyong, Fresno, CA (US)

(72) Inventor: KoongMeng Paul Xyong, Fresno, CA (US)

(21) Appl. No.: 16/368,821

(22) Filed: Mar. 28, 2019

(51) Int. Cl. A01K 91/04

(52) U.S. Cl. CPC A01K 91/04

(57) ABSTRACT

An umbrella rig 10 that allows the arms 30 to open for fishing and collapse for storage. Utilizing embodied passages 21 and integrated axis 23 inside a rigid cap 20, a simple one piece construction rigid cap 20 can be manufactured to allow the arms 30 to open and collapse without using multiple parts. In addition, a bolt 12 or magnets 32 can be used to hold together the rigid cap 20 and base 26 for fishing or collapsing the arms 30 for storage.

### BACKGROUND OF THE INVENTION

Most natural baits congregate in schools or bait balls as a defense mechanism against predators. A predatory fish naturally seeks out such schools to feed on. This makes umbrella rigs effective for fishing. In order to recreate a school of fish, umbrella rigs use arms to spread out teaser baits some with or without hooks, flashers or attractants. Umbrella rigs were originally made with fixed arms attached to a body which made them large, bulky and hard to store after use. Fishermen repeatedly bend the arms back and forth for use and storage which weakened the arms from wire fatigue. This ultimately caused the arms to break off after several use rendering the umbrella rig useless. U.S. Pat. No. US 2016/0165868 A1 to LeHew shows a system where the arms can be attached and detached by disassembling the umbrella rig to replace broken arms but a complete disassembly would be required for storage. U.S. Pat. No. US 2005/0050790 A1 to Higgins disclosed a complex release mechanism utilizing a pressure device that allowed the umbrella rig to collapse when a fish was hooked. In addition to a complex mechanism to collapse the umbrella rig, the device limited the user to only one arm having a hook for fishing. The non-patented Hyper Rig made by Jewel Bait Company is an umbrella rig with three arms that folds about an axis. This makes it difficult for users to manually realign the arms into their designated positions when weighted down by baits and weighted hooks. The non-patented Bumbershoot made by River2Sea requires curved arms with welded ends to attach to a metal c-ring held together by a screw inside the cap of the umbrella rig, it required multiple parts within the cap unit to allow the arms to collapse. A simpler unit is needed to reduce manufacturing time and cost. Although some have sought to create foldable or collapsible umbrella rigs to eliminate wire fatigue or to easily store the rig, there is a need for an umbrella rig that can easily collapse the arms without complex systems and one that does not require multiple parts in order for it to function.

### FIELD OF THE INVENTION

The present invention relates to artificial fishing baits, and more particularly to a collapsible umbrella rig used for fishing.

### SUMMARY OF THE INVENTION

In accordance with one embodiment a collapsible umbrella rig comprises a rigid cap and base which allows a plurality of arms to spread open and collapse; a bolt holds together a rigid cap and base.

In another embodiment a collapsible umbrella rig comprises a rigid cap and base which allows a plurality of arms to spread open and collapse; magnets hold together a rigid cap and base.

These and other features, aspects and advantages of the present invention will become better understood with reference to the following drawings, descriptions and claims.

### BRIEF DESCRIPTION OF THE DRAWING

In the drawings, closely related figures have the same number but different alphabetic suffixes.

FIG. 1 shows an exploded view of a collapsible umbrella rig in accordance with one embodiment.

FIG. 2 shows a collapsible umbrella rig in an open position.

FIG. 3 shows a cross-section of a collapsible umbrella rig in an open position.

FIG. 4 shows a collapsible umbrella rig in a closed position with arms collapsed down.

FIG. 5 shows a cross-section of a collapsible umbrella rig with arms attached in a collapsed down position for storage.

FIG. 6a to 6c shows a rigid cap with various views and a cross-section without arms attached.

FIGS. 7a to 7c shows a base with various views and a cross-section without arms attached.

FIG. 8 shows an exploded view of a similar collapsible umbrella rig incorporating magnets in accordance with another embodiment.

FIG. 9 shows a collapsible umbrella rig incorporating magnets in an open position.

FIG. 10 shows a cross-section of a collapsible umbrella rig in an open position,

FIG. 11 shows a collapsible umbrella rig in a closed position with arms collapsed down.

FIG. 12 shows a cross-section of a collapsible umbrella rig in a closed position with arms collapsed down.

FIG. 13a to FIG. 13c shows a rigid cap with various views and a cross-section without arms attached.

FIG. 14a to FIG. 14c shows a base with various views and a cross-section without arms attached.

FIG. 15 shows a collapsible umbrella rig in an open position with a bolt sitting flush inside the impression on top of the cap in accordance with another embodiment.

### DETAILED DESCRIPTION OF THE INVENTION

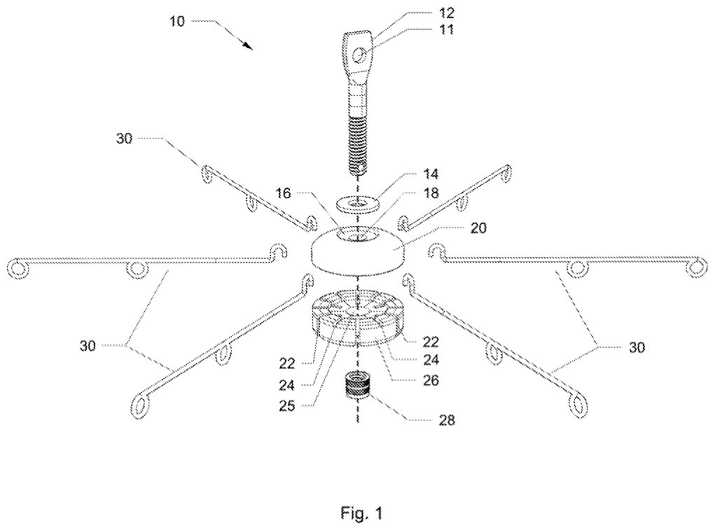

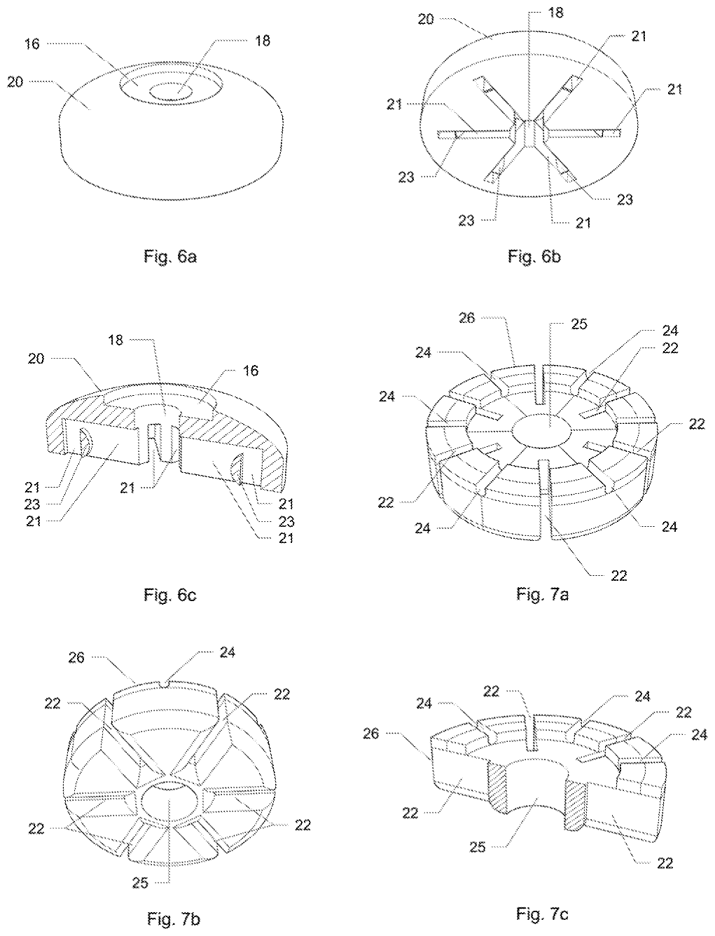

One embodiment of the collapsible umbrella rig 10 is illustrated in FIGS. 1, 2, 3, 4, 5, 6a, 6b, 6c, 7a, 7b, 7c. The collapsible umbrella rig 10 has a rigid cap 20 made of simple one piece construction with a plurality of embodied passages 21 having integrated axis 23 which allows a plurality of arms 30 to attach and rotate inside the embodied passages 21 located on the underside of the rigid cap 20. The rigid cap 20 is 3d printed from plastic materials incorporating the embodied passages 21 and integrated axis 23 into a singular entity. This reduces manufacturing costs and improves the quality of the umbrella rig. However, the rigid cap 20 and base 26 can consist of any other material that can be 3d printed, such as wood, metals, carbon fiber, epoxy resin, etc. An impression 16 houses a washer 14 at the top end of rigid cap 20. A base 26 with a plurality of notches 24 which helps guide and prevent the arms 30 from collapsing and slots 22 which allow the arms 30 to collapse downward. The base 26 is attached to the bottom of the rigid cap 20 by tightening a bolt 12 inserted through the top end of the rigid cap 20 through the washer 14, cap hole 18, base hole 25 and into thread insert 28. The rigid cap 20 and base 26 are both 3d printed from plastics.

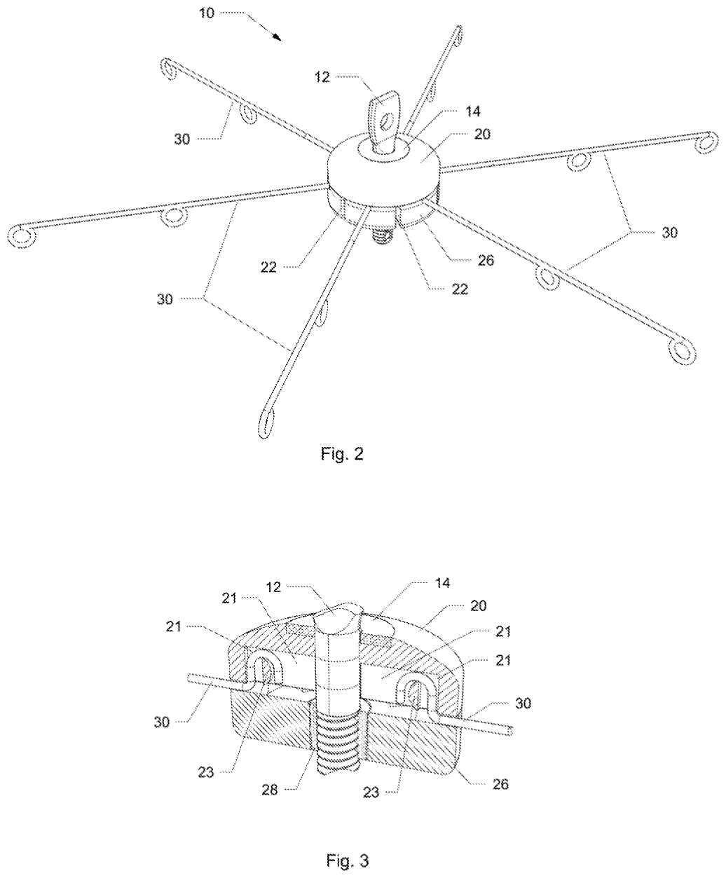

For use, a fishing line (not shown) is attached to the bolt 12 through the top bolt hole 11. Also, teaser lures-lures without hooks (not shown)-are attached along the arms 30 and lures with hooks (not shown) are attached at the end of some arms 30. One must first loosen the collapsible umbrella rig 10 by twisting the bolt 12 to allow a small gap between the rigid cap 20 and base 26. Next, holding the collapsible umbrella rig 10 upside down so the arms 30 are spread open, one turns the base 26 until the grooves 24 align with the arms 30 then tighten the bolt 12 to ready the collapsible umbrella rig 10 for use as shown in FIG. 2.

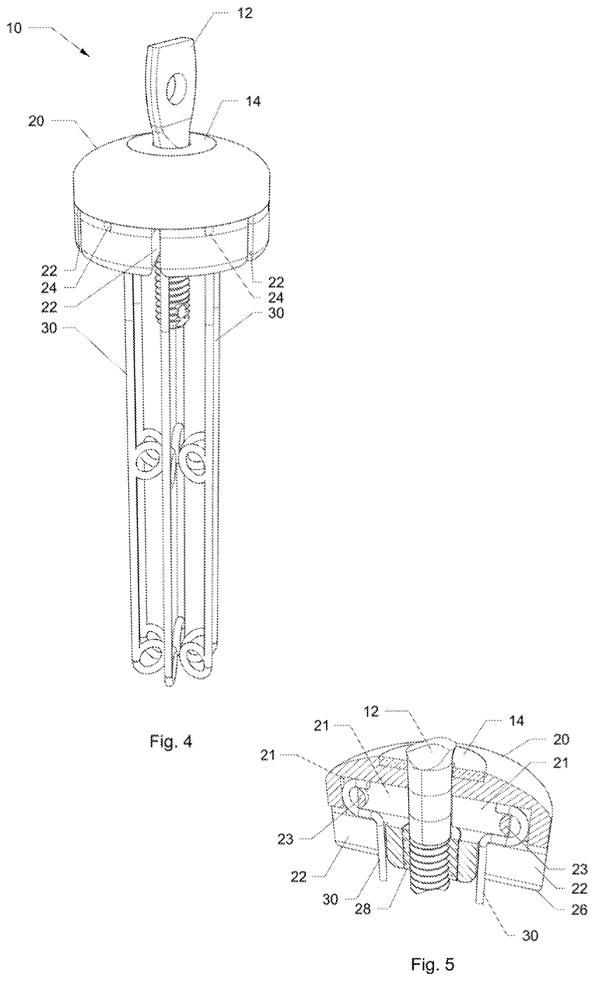

To collapse the umbrella rig 10 for storage, one first loosens the bolt 12 to allow a small gap between the rigid cap 20 and base 26. Next, holding the collapsible umbrella rig 10 upside down so the arms 30 are spread open, one turns the base 26 until the slots 22 align with the arms 30 then collapse the arms 30 downward for storage as shown in FIG. 4.

In another embodiment, the rigid cap 20a and base 26a is made from cast metals such as lead, aluminum, brass, etc.

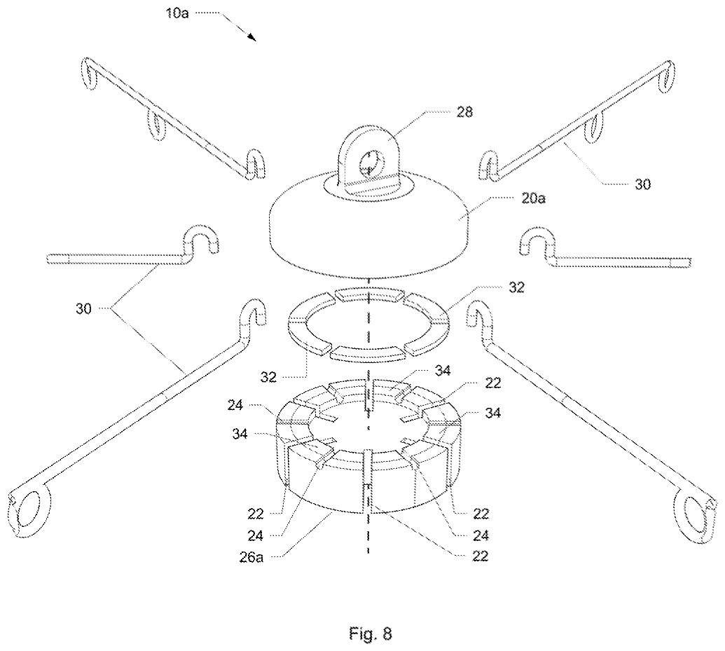

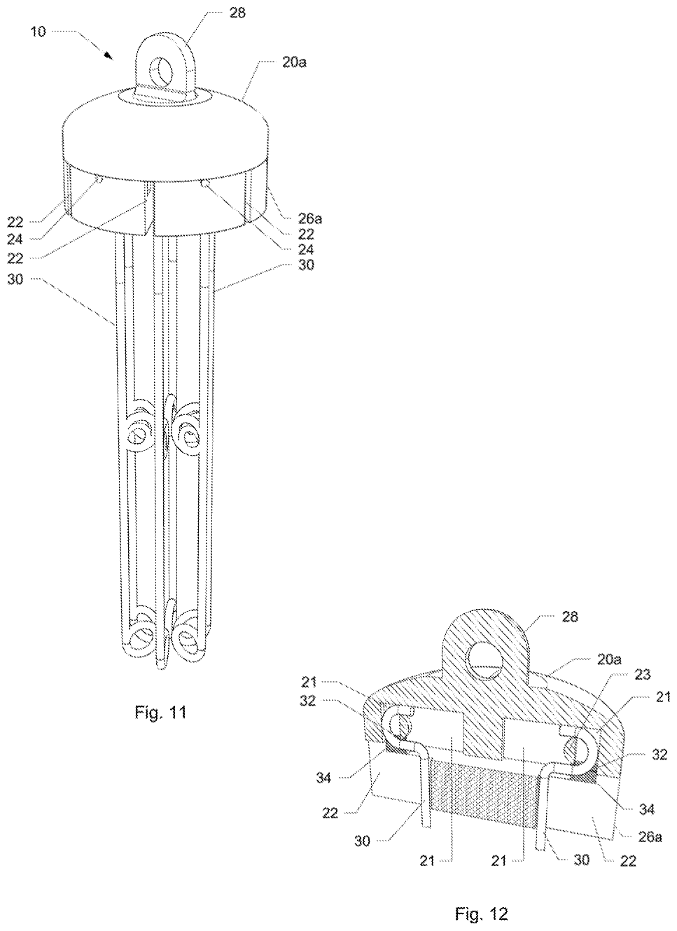

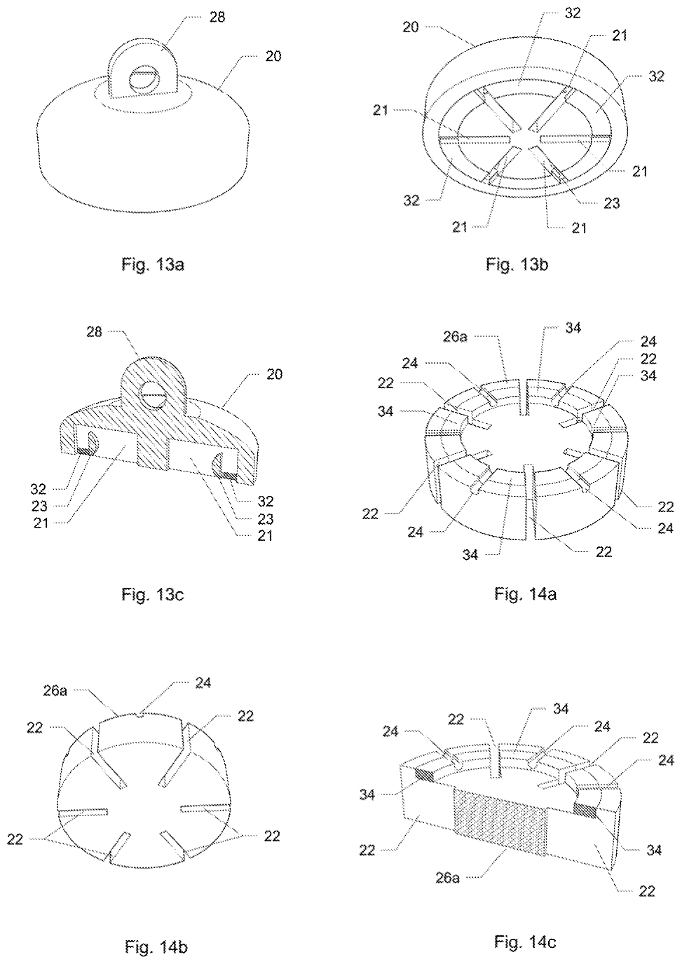

An additional embodiment is shown in FIGS. 8, 9, 10, 11, 12, 13a, 13b, 13c, 14a, 14b, 14c. The rigid cap 20a incorporates magnets 32 attached to the underside. The base 26a incorporates magnetic metals 34 to attach the rigid cap 20a and base 26a.

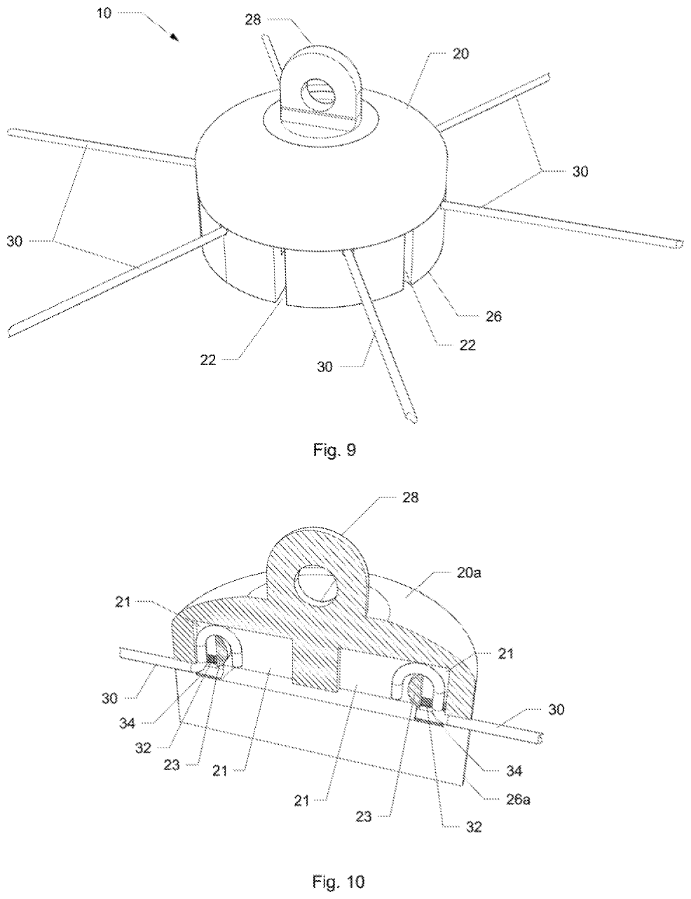

For use, a fishing line is attached to a handle 28 on top of the cap 20a. Next, holding the collapsible umbrella rig 10a upside down, pull the base 26 off the cap 20a, align the notches 24 with the arms 30 and reengage the magnets 32 with the magnetic metals 34 as shown in FIG. 9.

To collapse the umbrella rig 10a for storage; holding the umbrella rig 10a upside down, pull the base 26a apart from the cap 20a. Align the slots 22 with the arms 30 then collapse the arms 30 downward for storage as shown in FIG. 11.

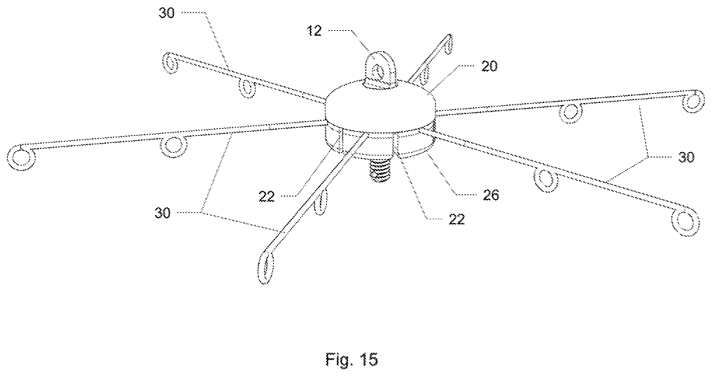

In another embodiment shown in FIG. 15 a bolt 12 rests inside impression 16 after tightening the bolt 12.

Accordingly, the reader will see that the collapsible umbrella rig of various embodiments can be used to collapse for easy storage easily and conveniently and will eliminate wire fatigue from users bending the wires for storage. In addition, the means to which it was manufactured, allows the rigid cap to be made as a singular unit which will reduce manufacturing costs and improve the quality of the umbrella rig.

Although the description above contains many specifications, these should not be constructed as limiting the scope of the embodiments. For example, the umbrella rig can have three arms instead of six as shown in the drawings, the rigid cap and base can have other shapes, such as oval, square, trapezoidal, triangular, etc; the arms can have different shapes, the bolt can have other shapes, the thread insert can be replaced with internal threads inside the base, etc.

Thus the scope of the embodiments should be determined by the appended claims and their legal equivalent, rather than by the examples given.

What is claimed is:

1. A collapsible umbrella rig comprising:
a. a rigid cap made of simple one piece construction with embodied passages having integrated axis forming a singular unit which allows a plurality of arms to attach, open and collapse.
b. a base with a plurality of grooves and slots is joined to said rigid cap which allows or prevents said arms from collapsing.

2. The collapsible umbrella rig of claim 1 wherein said means for joining said base to said rigid cap comprises of a bolt through a hole on top of said rigid cap to said base.

3. The collapsible umbrella rig of claim 1 wherein said bolt attaches to a threaded heat insert located inside said base.

4. The collapsible umbrella rig of claim 1 wherein said threaded heat insert and bolt is made of metal.

5. The collapsible umbrella rig of claim 1 wherein said internal threads are manufactured inside the base.

6. The collapsible umbrella rig of claim 1 wherein magnets and magnetic metals hold together said rigid cap and said base.

7. The collapsible umbrella rig of claim 1 wherein said rigid cap and said base is 3d printed.

8. The collapsible umbrella rig of claim 1 wherein said rigid cap and said base is made of plastic.

9. The collapsible umbrella rig of claim 1 wherein said rigid cap and said base is made from other materials such as aluminum, steel, brass, lead, wood, epoxy resin, carbon fiber, etc.

10. The collapsible umbrella rig of claim 1 wherein said arms are made from flexible metal wire.

11. The collapsible umbrella rig of claim 1 wherein a metal washer is pressed to the top of said rigid cap.

12. The collapsible umbrella rig of claim 1 wherein hookless teasers and baits with hooks are attached to said arms.

13. The collapsible umbrella rig of claim 1 wherein said number of arms are not limited to one or more arms.

14. The collapsible umbrella rig of claim 1 wherein said a bolt rest inside impression on top of the cap when tightened.
